(19) United States
(12) Patent Application Publication
(10) Pub. No.: US 2007/0041876 A1
(43) Pub. Date: Feb. 22, 2007

(54) Apparatus for liquid sample handling

(76) Inventor: Coulton Heath Legge, Ware (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/589,578

(22) Filed: Oct. 30, 2006

Related U.S. Application Data
(63) Continuation of application No. 10/394,402, filed on Mar. 19, 2003, now abandoned.
Application No. 10/394,402 is a continuation of application No. 09/637,745, filed on Aug. 11, 2000, now abandoned.

(30) Foreign Application Priority Data
Aug. 13, 1999 (GB) GB 9919034.0
May 8, 2000 (GB) GB 0011112.0

(51) Int. Cl. B01L 3/02

(52) U.S. Cl. 422/100

(57) ABSTRACT

There is provided according to the invention an apparatus for liquid sample handling which comprises: (a) a plurality of hollow capillaries, each being open at both ends and of defined internal volume, wherein on contact of an open end of a capillary with a sample, said defined volume of sample is drawn up into the capillary by capillary action; (b) a housing which retains the capillaries in their desired orientation; and (c) means to effect sample removal from the capillaries; and processes employing said apparatus.

### FIELD OF THE INVENTION

This invention relates to a novel apparatus for liquid sample handling, and uses thereof.

### BACKGROUND OF THE INVENTION

There is a continual need within industry, especially the pharmaceutical industry, for the miniaturisation of assays for such purposes as high-throughput screening or high-throughput analytical assays. These assays were originally performed in 12×8 (96 well) microtitre plates which utilised multi-channel pipettes for liquid sample manipulation (such as those supplied by Gilson and other companies). However, this process was manually labour intensive and yielded a significant quantity of waste plastic. Additionally, with the advent of 16×24 (384 well) and more recently, 32×48 (1536 well) microtitre plates, multi-channel pipettes have become redundant. There is thus a need for a liquid sample handling apparatus, susceptible to automation, capable of manipulating increasingly large numbers of samples and possessing a significant degree of accuracy required to transfer small volumes of samples.

We have now invented an apparatus capable of high-throughput liquid sample manipulation, while conferring a high level of volume accuracy upon dispensation.

### SUMMARY OF THE INVENTION

The present invention relates to an apparatus for liquid sample handling which comprises:
(a) a plurality of hollow capillaries, each being open at both ends and of defined internal volume, wherein on contact of an open end of a capillary with a sample, said defined volume of sample is drawn up into the capillary by capillary action;
(b) a housing which retains the capillaries in their desired orientation; and
(c) means to effect sample removal from the capillaries.

The present invention also relates to processes for employing said apparatus.

### BRIEF DESCRIPTION OF THE DRAWINGS

The invention will be illustrated by reference to the following figures:

FIG. 1 shows two example capillary arrays, such as a linear one dimensional array (A) and a two dimensional array (B).

FIG. 2 shows a general scheme for an embodiment of the apparatus of the present invention, comprising an array of capillaries, a cavity, a pressure supply and a control valve for regulating the pressure from a gas supply via a valve control unit.

FIG. 3 shows an example of a capillary array in a housing forming a cavity, in exploded view.

FIG. 4 indicates the results of the carryover into the sample investigation.

FIG. 5 indicates the results of the carryover into the source investigation.

### DETAILED DESCRIPTION OF THE INVENTION

Thus, according to one aspect of the present invention we provide an apparatus for liquid sample handling which comprises:
(a) a plurality of hollow capillaries, each being open at both ends and of defined internal volume, wherein on contact of an open end of a capillary with a sample, said defined volume of sample is drawn up into the capillary by capillary action;
(b) a housing which retains the capillaries in their desired orientation; and
(c) means to effect sample removal from the capillaries.

We prefer that the plurality of capillaries are arranged in a regular orientation within the housing. When it is desired to dispense into a microtitre plate, this has the advantage that liquid may be dispensed into the wells of a microtitre plate simultaneously.

The housing may be manufactured of any material that has appropriate rigidity; preferably it is manufactured of a plastics material.

We particularly prefer that the plurality of capillaries are arranged in a one dimensional array, eg. a row. When it is desired to dispense into a microtitre plate, this has the further advantage that liquid may be dispensed into an entire row of wells of a microtitre plate simultaneously.

We especially prefer that the plurality of capillaries are arranged in a two dimensional array. For example they may be arranged in the housing in arrays of 8×12, 16×24, 32×48 (especially when this conforms to the conventional microtitre plate format) or any other desired geometrical arrangement. This has the further advantage that liquid may be dispensed into an entire microtitre plate simultaneously.

It will be appreciated that the plurality of capillaries may be conformed or adapted to be suitable for dispensation onto any substrate and no limitation to microtitre plates is intended.

It will also be appreciated that the plurality of capillaries may be filled from above as well as from below.

Preferably, the means to effect sample removal is means to apply differential pressure between the ends of the capillaries. This has the advantage of automated application, thus eliminating the need for manual sample ejection as with other liquid manipulation techniques.

Preferably, the means to apply differential pressure between the ends of the capillaries comprises means to apply pressure to one end of the capillaries.

Preferably, also, the means to effect sample removal from the capillaries is means to simultaneously remove (eg. eject) sample from the plurality of capillaries.

In one preferred embodiment, said means may be means to supply pressurised gas into an enclosed cavity formed around one end of the capillaries. This has the advantage that dispensations from multiple capillaries may take place simultaneously and the quantity of pressurised gas used can be strictly regulated.

We prefer that the above mentioned enclosed cavity is formed by the housing. We particularly prefer that the cavity formed by the housing is formed from two pressure sealed separable portions: one portion retaining the capillaries and one portion provided with means to supply pressurised gas to the cavity.

The particular advantage of having these two separable portions is that the portion retaining the capillaries can be disposed of if desired without necessity to dispose of the remainder of the apparatus. However, disposal of the portion retaining the capillaries may not be necessary with multiple usage since, as described later, we also provide as an aspect of the invention, a method of recycling the apparatus through washing steps.

In an alternative embodiment, said means may be means to supply pressurised gas to the ends of the capillaries individually, for example using a suitable arrangement of pipework and valves. This has the advantage, when desired, that the multiple dispensations need not take place simultaneously and dispensation of each capillary can be individually controlled.

Alternatively the means to apply differential pressure between the ends of the capillaries comprises applying a vacuum to one end of the capillaries.

In an alternative embodiment of this aspect of the present invention the enclosed cavity formed around one end of the capillaries may also act as a reservoir for a liquid.

According to this embodiment, once the capillaries have been filled up with a first liquid the reservoir may be filled with a second liquid (which may or may not be the same as the first liquid). The amount of second liquid in the reservoir should be enough to cover the ends of some or all of the capillaries. The capillaries may be emptied of first liquid by applying pressure (eg. gas pressure) in the cavity. Depending on the amount of pressure applied, and its duration, only the first liquid may be ejected, or first liquid and some second liquid may be ejected.

It will be appreciated that this procedure is advantageous because assays may be rapidly performed by dispensing both sample and buffer reagents sequentially (such as when the reservoir contains buffer). Additionally, wherein the second solution is water, a buffer or similar reagent, this procedure will act as a capillary washing step, thus eliminating the need for repeating washing steps.

According to an alternative aspect of this embodiment, instead of applying pressure in the cavity, a vacuum may instead be applied such that the sample in the capillary may be transferred to the reservoir.

It will be appreciated that this procedure may be advantageous in situations where a sample is required to be diluted.

Alternatively the means to effect sample removal from the capillaries is means whereby the liquid sample is withdrawn from the capillaries upon contact of said capillaries with a suitable surface. For example, such surface will have wicking or other absorbent properties (such as a fibrous material or a gel) which cause the sample to be withdrawn.

Alternatively the means to effect sample removal from the capillaries is means to achieve electrophoretic migration (eg. electro-osmotic flow) of a sample from the capillaries. Electrophoretic migration of a sample from the capillaries may be achieved by forming an electric field (including a cathode and an anode) between the location of the sample and its desired destination. As a consequence of such an electric field, a charged sample or electrolyte will migrate to the electrode of opposite charge to that of the sample.

Capillaries may be manufactured from a range of materials eg. stainless steel, glass (such as fused silica) or quartz, preferably glass or quartz. We particularly prefer the capillaries to be made of fused silica, especially synthetically fused silica.

We prefer that the capillaries are coated or surface treated. We particularly prefer that the coating or surface treatment involves coating or treating with a non-wetting agent. We especially prefer that the non-wetting agent is a coating of polyimide.

It will be appreciated that the capillaries may be coated or surface treated on their inner surface, outer surface, or on both surfaces. Coating or surface treatment on the outer surface has the advantage that liquid is not lost onto the outer surface of the capillary. An external coating may also resist brittleness in the capillaries and allow them to be flexible. Coating or surface treatment on the inner surface of the capillary will improve liquid ejection efficiency in addition to the efficiency of cleaning.

As an alternative embodiment of the present invention, we prefer that the capillaries may be modified such that one of their ends is sharp and pointed or otherwise adapted to enable the capillaries to perform a piercing function when they make contact with a surface, prior to sample removal. Such an embodiment will be useful in a variety of functions, such as sterile assays, where the sample is protected by a septum or other shield which may be pierced by the end of the capillary.

For most current applications it will be preferred that the internal volume of each capillary is between 50 nl and 1 μl, although it will be appreciated that volumes both <50 nl and >1 μl may be contemplated. It may be particularly preferred that the internal volume of each capillary is between 50 nl and 250 nl. It will be understood that there is no requirement for the plurality of capillaries to be all of the same internal volume.

As an alternative embodiment of the present invention, we provide a mechanism for reducing the internal volume of the capillaries. Preferably, this mechanism will be achieved by insertion of an object into a capillary such that the internal volume of the capillary is reduced by displacement. Preferably, the object will be a solid rod or a capillary with a more narrow diameter.

A further aspect of the present invention is the use of the apparatus in liquid sample handling.

A still further aspect of the present invention is a process for liquid sample transfer using an apparatus according to the first aspect of the invention which comprises:
(a) contacting the lower open end of the capillaries with the liquid to be transferred;
(b) uptake of liquid into the capillaries by capillary action; and
(c) effective removal of the liquid sample in each capillary into the receptacle to which it is to be transferred.

We prefer that the effective removal of the sample is achieved by application of pressure to the end of the capillaries. Preferably the pressure is the pressure of pressurised gas. The gas will be a non-toxic gas such as nitrogen or air, preferably air. Typically, the pressure will be applied in a pulse. The pulse may be applied by turning on and off a valve from the source of pressurised gas. Desirably, the valve will be electronically controlled.

To achieve a suitable internal capillary volume, the key variables are internal diameter and length. Wherein the internal capillary volume represents 250 nl, several (non-limiting) sizes of capillary may be utilised, such as those defined by the parameters detailed in Table 1. An example of a capillary having an internal volume of 50 nl is Capillary D, the parameters for which are detailed in Table 7.

In order to achieve a high accuracy in sample volume dispensation, the dimensions of the capillary should appropriately be selected for the liquid to be handled so that the capillary is filled to its brim by capillary action. The relationship between acceptable capillary dimensions and the properties of the liquid follow accepted physical properties eg. that liquids with higher surface tension will draw up a capillary to a greater height than those with a lower surface tension. In fact, it is known that a liquid will rise within a capillary to a height, h that can be calculated from the following equation:

$$h = \frac{2 γ cos θ}{ρ gR}$$

wherein γ is the surface tension of the liquid being used (eg. 72.8 N/m for water), ρ the density of the liquid, θ the angle of contact (between 0 and 20 degrees for water), R is the internal radius of the capillary and g is the gravitational acceleration. Therefore, if a capillary of length l is used and l is shorter than h, then the capillary will be expected to completely fill with the liquid. For use in the apparatus according to the invention l should be selected to be less than h.

An investigation was performed to determine the accuracy of sample transfer demonstrated by the apparatus of the present invention. This involved two separate experiments to compare the transfer accuracy of capillary types A and B (see Table 1). In both experiments, the capillaries were immersed in a sample of tartrazine in dimethyl sulphoxide (DMSO) and allowed to completely fill by capillary action. The samples were then ejected into an empty microtitre plate using 0.5 bar of air pressure and this procedure was repeated 5 or 6 further times, with methylated spirits (IMS) rinsing in between. As a measure of accuracy, the quantity of fluorescence for each microtitre plate well was then determined (absorbance mode, 405 nm).

Amongst the advantages of the invention is the fact that since essentially the entire volume of sample that is drawn up into the capillary is dispensed there is minimal sample wastage; this contrasts with some dispensing systems where more sample is withdrawn from the sample source than is dispensed.

The results of this investigation can be seen in Tables 2 and 3, wherein columns 1 to 6 (Table 2) or 1 to 5 (Table 3) indicate results of multiple dispenses from a 1-dimensional array of 7 (Table 2) and 6 (Table 3) capillaries. Column 6 of Table 3 shows the results of drawing up clean IMS instead of sample after the rinse. Rows A to F or G in Tables 2 and 3 indicate results for multiple dispensations from the same capillary. Mean, standard deviation and the coefficient of variance (% CV) results are given for each run, each capillary and across all samples.

$$\% CV = \frac{Standard Deviation}{Mean} ⨯ 100$$

The data shown in Table 4 summarises the conclusions from the dispensation accuracy investigation, and as a consequence of a lower average % CV value, use would be made of capillary B in preference to capillary A. The reading in position A5 of Table 2 was defective for an unknown reason and was ignored in the statistical analysis.

Capillary filling was achieved by immersion of the capillary in the relevant liquid sample. Capillary action would then fill the capillary. It was found that in all 3 types of capillary used with the present invention, filling was routinely achieved within 2 seconds. Additionally, it was observed that no overflow of the liquid sample occurred, nor was there any significant seepage from the input end of the capillary once removed from the liquid sample.

These results demonstrate that the apparatus and process according to the invention achieve the objective of accurate and reproducible liquid handling.

Experiments have been performed using the above mentioned capillary types with a control sample (DMSO), to deduce a suitable protocol for the amount of pressure required for sample ejection and the duration of such a pressure. To calculate the amount of pressure required for dispensation (P), Poiseuilles equation was used:

$$P = 32 \frac{μ vl}{{d}^{2}}$$

wherein μ=viscosity of sample liquid (DMSO=2.5×10⁻³ Pa s),
v=velocity of sample,
l=capillary length,
d=capillary internal diameter.

To calculate the duration that such a pressure is required for (dt), the following equation was then applied:

$$dt = \frac{l}{v}$$

For each of the 3 capillary types, assuming a standard velocity of 2 m/s, the pressure required (P) was calculated and the time for dispensation was then calculated at that pressure, and the resultant values can be seen in Table 5. A suitable liquid manipulation protocol would suitably take account of the following factors:

(a) length of capillary (Table 1), wherein a short length would present problems in removing samples at low well levels and longer lengths would require a longer duration of pressure application for liquid dispensation and would necessitate the use of a narrow inner diameter;

(b) inner diameter (Table 1), wherein a narrow inner diameter requires a higher pressure of gas for dispensation and narrow diameter capillaries may be susceptible to blockage;

(c) pressure required (Table 5), wherein a high pressure of gas supply may cause shattering of the capillary housing; and

(d) time of dispensation (Table 5), wherein a short dispensation time may result in sample retention within the capillary.

Therefore, applying these factors to a required internal capillary volume of 250 nl, use would be made of capillary type B in preference to A or C.

Dispensation accuracy using capillary B was also investigated using a capillary array of 32 capillaries. The test solution was 16 mg/ml tartrazine in DMSO which was aspirated and then dispensed into a 384 microtitre plate. After dispensing, the wells were diluted with 100 μl water and the fluorescence was calculated at 405 nm using a Tecan Spectralmage and the values were equated with a standard curve to ascertain the exact volume dispensed. The results of this accuracy investigation are shown in Table 8, where it can be seen that the average volume dispensed is very close to the target 250 nl, and the % coefficient of variance for this experiment is very low indicating that the dispensed volume is repeatable. These results are comparable with the accuracy and repeatability displayed by the row of 6 capillaries in Table 3 for the same capillary type indicating that the apparatus according to the present invention, may be scaled up to larger arrays of capillaries with no adverse effect on dispensation performance.

Wherein more than one sample of liquid is required for dispensation, for example during a multi-reagent assay, suitable washing steps will be required to prevent sample carry-over when it is desired not to have to dispose of the capillary array between steps. To investigate the potential of sample carry-over, capillaries were successively filled with a fluorometric sample (eg. fluoroscein) and neat DMSO and ejected, separated by a suitable washing procedure. Upon fluorometric analysis of all ejected samples, the carry over of fluoroscein could then be deduced. The fluorometric results of this carry-over investigation can be seen in Table 6, wherein the three washing steps were observed to be sufficient to reduce the carry-over to a very acceptable level, i.e. less than 0.5%.

The protocol examined was as follows:
(a) capillaries (represented by rows A to H) filled with fluoroscein;
(b) fluoroscein ejected into dry plate (Column 1);
(c) steps (a) and (b) repeated and ejected into different wells (Column 2);
(d) capillaries filled with neat DMSO and ejected three times;
(e) capillaries filled with neat DMSO;
(f) neat DMSO ejected into a dry plate with 3 pressurised gas pulses to expel residue (Column 3);
(g) steps (e) and (f) repeated (Column 4);
(h) Repeat steps (a) to (g) (Columns 5-8).

Thus, according to the invention we provide a process for multiple liquid sample transfer using an apparatus according to the first aspect of the invention which comprises:
(a) contacting the lower open end of the capillaries with the first liquid to be transferred;
(b) uptake of liquid into the capillaries by capillary action;
(c) effective removal of the liquid sample in each capillary into the receptacle to which it is to be transferred;
(d) contacting lower open end of capillaries with rinsing liquid;
(e) uptake of rinsing liquid into the capillaries by capillary action;
(f) effective removal of the rinsing liquid in each capillary into a suitable waste receptacle;
(g) if desired, repetition of steps (d) to (f) one or more times;
(h) contacting the lower open end of the capillaries with a further liquid to be transferred;
(i) uptake of the further liquid sample into the capillaries by capillary action; and
(j) effective removal of the further liquid sample in each capillary into the receptacle to which it is to be transferred.

It will be understood that steps (d) to (j) may be repeated one or more times if desired.

The number of repetitions of step (g) deemed necessary will be selected according to the amount of carryover obtained between samples. There are 2 situations where carryover is disadvantageous; the first is when a small amount of the sample is retained on the internal surfaces of the capillary after sample ejection (carryover in the sample); and the second occurs in a situation when a capillary aspirates a second sample and a small amount of the first sample is retained on the external surfaces of the capillary and is carried over into said second sample (carryover in the source volume).

The carryover effect was investigated to accurately determine the number of repetitions desirably required for step (g):

Carryover in the Sample

This experiment utilised an array of 16 capillaries (250 nl; capillary B) arranged in an apparatus according to the present invention.

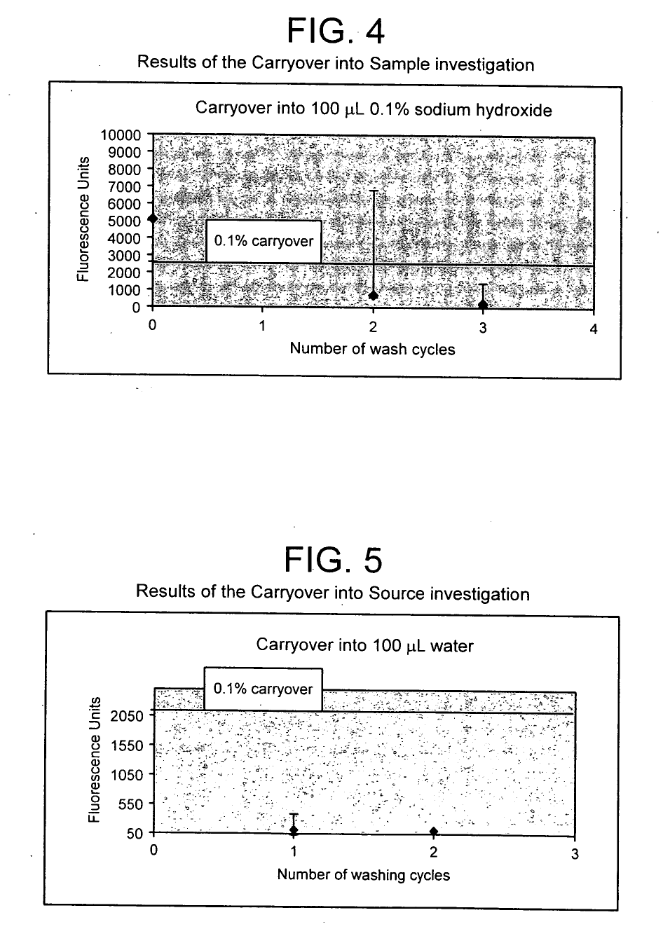

The capillary array was immersed in the source sample (fluorescein in DMSO) and then dispensed into a 384-well ‘waste’ microtitre plate. The array was then washed by performing a series of wash cycles (a 250 nl aspiration of water followed by a 250 nl dispense, repeated 1-4 times). Following these wash cycles, a sample of water was then aspirated and then dispensed into a clean, dry 384-well microtitre plate. The wells of the plate were then diluted with 100 μl 0.1% sodium hydroxide solution and the fluorescence was determined using a Tecan Spectrafluor. These fluorescence values were compared with the fluorescence value of 0.1% fluoroscein in DMSO (which was calculated to be approximately 2600 fluorescence units) and can be seen in FIG. 4. These results indicate that a minimum of 3 wash cycles are required to reduce the carryover in all wells to below 2600 fluorescence units.

Carryover in the Source

This experiment also utilised an array of 16 capillaries (250 nl; capillary B) arranged in an apparatus according to the present invention.

The capillary array was immersed in the source sample (fluoroscein in DMSO) and then dispensed into a 384-well ‘waste’ microtitre plate. The array was then washed by performing a series of wash cycles (a 250 nl aspiration of water followed by a 250 nl dispense, repeated 1-4 times). Following these wash cycles, a sample of water was then aspirated and the capillaries were immersed into a 384-well microtitre plate, the wells of which contained 100 μl water (to represent a second source plate). The fluorescence was determined using a Tecan Spectrafluor and the values were compared with the fluorescence value of 0.1% fluoroscein in DMSO (which was calculated to be approximately 2200 fluorescence units) and can be seen in FIG. 5. These results indicate that the carryover into the source wells was negligible.

Preferably the number of repetitions of step (g) is one or more, more preferably two or more, especially two.

The rinsing liquid will suitably be fully miscible with the sample liquid. When the sample liquid is aqueous, the rinsing liquid is preferably water.

As a further aspect of the present invention, we provide an apparatus for liquid sample handling which comprises
(a) a plurality of hollow capillaries, each being open at both ends and of defined internal volume, wherein on contact of an open end of a capillary with a sample, said defined volume of sample is drawn up into the capillary by capillary action; and
(b) a housing which retains the capillaries in their desired orientation.

In a further embodiment of the invention, we provide an apparatus for liquid sample handling which comprises
(a) a plurality of hollow translucent capillaries, each being open at both ends and of defined internal volume, wherein on contact of an open end of a capillary with a sample, said defined volume of sample is drawn up into the capillary by capillary action;
(b) a housing which retains the capillaries in their desired orientation;
(c) means to provide each capillary with photonic isolation from a neighbouring capillary;
(d) optical instrumentation and circuitry adapted to read a photonic response or event in each capillary; and
(e) means to effect sample removal from the capillaries.

Translucent capillaries will preferably be manufactured of glass (such as fused silica) or quartz. Fused silica, especially synthetically fused silica, is preferred.

Means to provide each capillary with photonic isolation from a neighbouring capillary may comprise an air space and/or a coating. The coating may be a non-wetting coating eg. of polyimide in accordance with an earlier aspect of the invention.

As described in PCT/EP98/05838 (WO99/13986; Glaxo Group Limited et al), the contents of which application are herein incorporated by reference, capillary walls are capable of acting as an optical waveguide which can very efficiently couple and pipe light out from the enclosed liquid. Preferably a photonic response or event is measured at the end of the capillary from which the sample is taken up by capillary action. The purpose of the photonic isolation of each capillary is to reduce and preferably eliminate “cross-talk” or interference in signal between one capillary and another.

The photonic response or event will be measured in a photometric assay. This aspect of the invention is useful because it allows a photometric measurement to be made in the samples which are being handled in real time. This is especially useful when the measurement may change with time eg. through reaction. Reactions which may cause a measurement to change include degradation reactions and other reactions in response to light. Such reactions will typically be unwanted and a means to detect them is valuable for process control. Alternatively the capillary may be coated on its internal surface with a reagent capable of intentionally reacting with the sample. The reaction may then be followed using a photometric assay.

Photometric assays include any assays in which photons are emitted or absorbed such as absorbance assays, fluorescence assays luminescence assays, phosphorescence assays and assays based on scattering (eg. Raman or Nephelometry) in liquids containing particles.

For fluorescence applications, the fluorescence signal may be generated by one or more fluorophores attached onto target molecules or within target molecules (autofluorescence). Such fluorescence may be induced by processes involving one or more photons.

For absorbance assays it would be usual to illuminate one surface of the liquid in each capillary with light and measure transmitted light at the other surface of the capillary. Measurement will consist of measuring the number of photons transmitted at a fixed wavelength. Alternatively absorbance spectra may be measured over a range of wavelengths.

For fluorescence assays one possible arrangement is similar to that described above for absorbance assays, i.e. such that one surface of the liquid is illuminated with light of a fixed wavelength and the emitted light is measured from the other surface. Measurement will consist of measuring the number of photons emitted at a fixed wavelength which will generally be a different wavelength from that of the exciting light. Alternatively, the number of photons emitted over a range of wavelengths may be measured.

Excitation of the sample can, in principle, be achieved by illumination of the sample from any angle. It is envisaged, although not preferred, that the sample may be illuminated from the side eg. by an arrangement which includes a light-guide.

An example method of excitation for fluorescence assays is with a Xenon flash lamp with an appropriate excitation filter eg. one in the range 300-700 nm. A filter band width of 10 nm or less will be preferred. Generally measurement of detected light will be made after passage of the light through an appropriate emission filter.

Photon collection measurements will generally be made with a photomultiplier tube, photodiode or charged coupled device.

Generally photon collection will be performed on each capillary sequentially which will involve providing means to move the detector or the capillary array from one location to another. However when photon collection is performed with a charge coupled device, it may be possible to collect photons in some or all capillaries simultaneously which has obvious advantages in terms of speed of reading and mechanical simplicity.

Preferably the housing will be manufactured of a material which gives a low back-ground signal in the technique employed.

Further details of the employment of this aspect of the invention will be apparent by reference to PCT/EP98/05838.

An additional embodiment of the present invention is wherein the capillaries within the housing are not all of the same length. For example, if the housing is lowered into a shallow sample reservoir, a situation would occur such that only longer capillaries would contact the sample and completely fill. Subsequent immersion of all capillaries into a deeper second sample, such that shorter capillaries would also contact the sample, would allow these shorter capillaries to completely fill with the second sample. The longer capillaries would not be affected by the second sample as these were previously filled. It will be understood that this embodiment may extend to two or more differing capillary lengths.

A further embodiment of the present invention is wherein one or more capillaries may be moved along a vertical axis within the housing. This embodiment would allow strict control over which capillaries would fill with sample, such that only certain rows or columns of capillaries (or even a single capillary) may fill with sample if desired.

A further aspect of this embodiment is wherein one or more capillaries may be reformatted within the plurality by altering the position of the capillaries within the housing, once filled with sample. This aspect would be advantageous in a situation where the position of capillaries within the housing may be altered after being filled with sample, such that they may be in a more convenient position for dispensation, eg. adjacent, in a row or in a column.

It will be understood that reference to liquid sample throughout the specification should extend inter alia to the use of suspension samples, colloids and samples containing beads, such as small glass, polymer or magnetic beads, which may suitably be drawn up and ejected as with liquid samples.

Table 1 describes the different sizes of capillary which may be used to achieve an internal capillary volume of 250 nl.

TABLE 1
Dimensions of the differing 250 nl capillaries

| Capillary | Outer Diameter | Inner Diameter | Length |
|---|---|---|---|
| Type | (μm) | (μm) | (mm) |
| A | 375 | 100 | 31.8 |
| B | 375 | 150 | 14.1 |
| C | 350 | 250 | 5.1 |

Table 2 indicates the results from the dispensation accuracy investigation using capillary A.

TABLE 2
Results of a dispensation accuracy investigation using capillary A

| | | | | | | | | Average | SD | % CV |
|---|---|---|---|---|---|---|---|---|---|---|
| | 1 | 2 | 3 | 4 | 5 | 6 | 7 | 8 | 9 | 10 |
| A | 1.0487 | 1.0362 | 1.2364 | 1.2197 | 0.6654 | 1.0854 | | 1.1253 | 0.0856 | 7.6087 |
| B | 1.3082 | 1.1414 | 1.2245 | 1.2682 | 1.2400 | 1.2094 | | 1.2320 | 0.0516 | 4.1860 |
| C | 1.0575 | 1.1996 | 1.2334 | 1.2013 | 1.2350 | 1.2723 | | 1.1999 | 0.0682 | 5.6808 |
| D | 1.2421 | 1.1343 | 1.1511 | 1.0840 | 1.1871 | 1.1998 | | 1.1664 | 0.0505 | 4.3334 |
| E | 1.0816 | 1.2896 | 1.2303 | 1.2679 | 1.3125 | 1.2768 | | 1.2431 | 0.0763 | 6.1418 |
| F | 1.2837 | 1.2112 | 1.1861 | 1.0841 | 1.2331 | 1.2347 | | 1.2055 | 0.0617 | 5.1222 |
| G | 1.0851 | 1.1750 | 1.2819 | 1.2903 | 1.2807 | 1.3251 | | 1.2397 | 0.0831 | 6.7008 |
| H | | | | | | | | | | |
| I | A5 ignored in analysis | | | | | | | | | |
| J | | | | | | | | Over whole plate | | |
| Mean | 1.1581 | 1.1696 | 1.2205 | 1.2022 | 1.2481 | 1.2291 | | 1.2035 | | |
| SD | 0.10599 | 0.0726 | 0.03836 | 0.07987 | 0.03957 | 0.071 | | 0.07904 | | |
| % CV | 9.15149 | 6.20728 | 3.14298 | 6.64398 | 3.17027 | 5.77657 | | 6.56741 | | |

Table 3 indicates the results from the dispensation accuracy investigation using capillary B.

TABLE 3
Results of a dispensation accuracy investigation using capillary B

| | | | | | | | | Average | SD | % CV |
|---|---|---|---|---|---|---|---|---|---|---|
| | 1 | 2 | 3 | 4 | 5 | 6 | 7 | 8 | 9 | 10 |
| A | 1.1450 | 1.2603 | 1.1718 | 1.2447 | 1.2068 | 0.0407 | | 1.2057 | 0.0432 | 3.5840 |
| B | 1.1716 | 1.2097 | 1.1708 | 1.1910 | 1.1540 | 0.0382 | | 1.1794 | 0.0191 | 1.6232 |
| C | 1.1732 | 1.2341 | 1.1821 | 1.1546 | 1.1353 | 0.0396 | | 1.1759 | 0.0333 | 2.8296 |
| D | 1.1625 | 1.2392 | 1.1656 | 1.2025 | 1.1441 | 0.0406 | | 1.1828 | 0.0340 | 2.8733 |
| E | 1.2091 | 1.2533 | 1.1994 | 1.1516 | 1.1682 | 0.0414 | | 1.1963 | 0.0352 | 2.9459 |
| F | 1.1627 | 1.2349 | 1.2945 | 1.1549 | 1.0349 | 0.0447 | | 1.1764 | 0.0872 | 7.4148 |
| G | | | | | | | | | | |
| H | | | | | | | | | | |
| I | | | | | | | | | | |
| J | | | | | | | | | | |
| | | | | | | | | Over whole plate | | |
| Mean | 1.1707 | 1.2386 | 1.1974 | 1.1832 | 1.1406 | | | 1.1861 | | |
| SD | 0.01947 | 0.01611 | 0.0448 | 0.03375 | 0.0525 | | | 0.04846 | | |
| % CV | 1.66272 | 1.30039 | 3.7413 | 2.8521 | 4.60291 | | | 4.08579 | | |

Table 4 summarises the results from the dispensation accuracy investigations described in Tables 2 and 3.

TABLE 4
Summary of dispensation accuracy investigation

| | | % CV over all | Optimum | Maximum |
|---|---|---|---|---|
| Capillary | Length (mm) | samples | % CV | % CV |
| A | 31.8 | 6.6 | 4.2 | 7.6 |
| B | 14.1 | 4.1 | 1.6 | 7.4 |

Table 5 describes the pressure of gas required and the duration of such a pressure suitable to eject a 250 nl sample.

TABLE 5
Pressure and dispensation times required for the 250 nl capillary types

| Capillary Type | P (bar) | dt (s) |
|---|---|---|
| A | 5.0 | 0.015 |
| B | 1.0 | 0.007 |
| C | 0.13 | 0.002 |

Table 6 contains the results of a sample carry-over experiment when capillaries were filled successively with 2 samples and ejected, separated by three washing steps.

TABLE 6
Results of the fluoroscein carry-over experiment

| | | | | | | | | | | Average | SD | % CV |
|---|---|---|---|---|---|---|---|---|---|---|---|---|
| | 1 | 2 | 3 | 4 | 5 | 6 | 7 | 8 | 9 | 10 | 11 | 12 |
| A | 9112 | 10080 | 28 | 25 | 9407 | 9590 | 26 | 26 | | 9547 | 406 | 4.25 |
| B | 9098 | 8329 | 15 | 15 | 9398 | 9996 | 18 | 3 | | 9205 | 693 | 7.53 |
| C | 9219 | 10151 | 21 | 19 | 9830 | 10382 | 18 | 18 | | 9896 | 505 | 5.10 |
| D | 9590 | 8629 | 16 | 15 | 9558 | 9606 | 19 | 5 | | 9346 | 478 | 5.12 |
| E | 9118 | 9556 | 26 | 31 | 9598 | 9859 | 35 | 35 | | 9533 | 307 | 3.22 |
| F | 9380 | 8839 | 16 | 10 | 9554 | 10134 | 11 | 7 | | 9477 | 534 | 5.63 |
| G | 10267 | 10606 | 25 | 28 | 9799 | 9975 | 36 | 35 | | 10162 | 354 | 3.48 |
| H | 9638 | 8323 | 18 | 25 | 9195 | 8306 | 18 | 7 | | 8866 | 661 | 7.46 |
| I | | | | | | | | | | | | |

| J | Above results based on sample only | | | | | | | |
|---|---|---|---|---|---|---|---|---|
| | Sample | Sample | DMSO | DMSO | Sample | Sample | DMSO | DMSO |
| Average | 9428 | 9314 | 21 | 21 | 9542 | 9731 | 23 | 17 |
| SD | 375.018 | 841.302 | 4.7942 | 6.87386 | 197.452 | 591.448 | 8.33573 | 12.5996 |
| % CV | 3 97781 | 9.03254 | 23.2446 | 32.7327 | 2.06921 | 6.07798 | 36.843 | 74.1153 |

Table 7 describes the dimensions of a capillary used to achieve an internal capillary volume of 50 nl.

TABLE 7
Dimensions of the 50 nl capillary

| Capillary Type | Inner Diameter (μm) | Length (mm) |
|---|---|---|
| D | 75 | 11.32 |

Table 8 indicates the results of the dispensation accuracy investigation for an array of 32 capillaries.

TABLE 8
Dispensation accuracy using a 32 capillary array

| Capillary | Average | Maximum | Minimum | |
|---|---|---|---|---|
| Type | Volume (nl) | Volume (nl) | Volume (nl) | % CV |
| B | 245.93 | 262.63 | 223.60 | 2.79 |
| B | 244.02 | 272.87 | 217.53 | 3.45 |
| B | 247.76 | 269.48 | 223.70 | 3.49 |

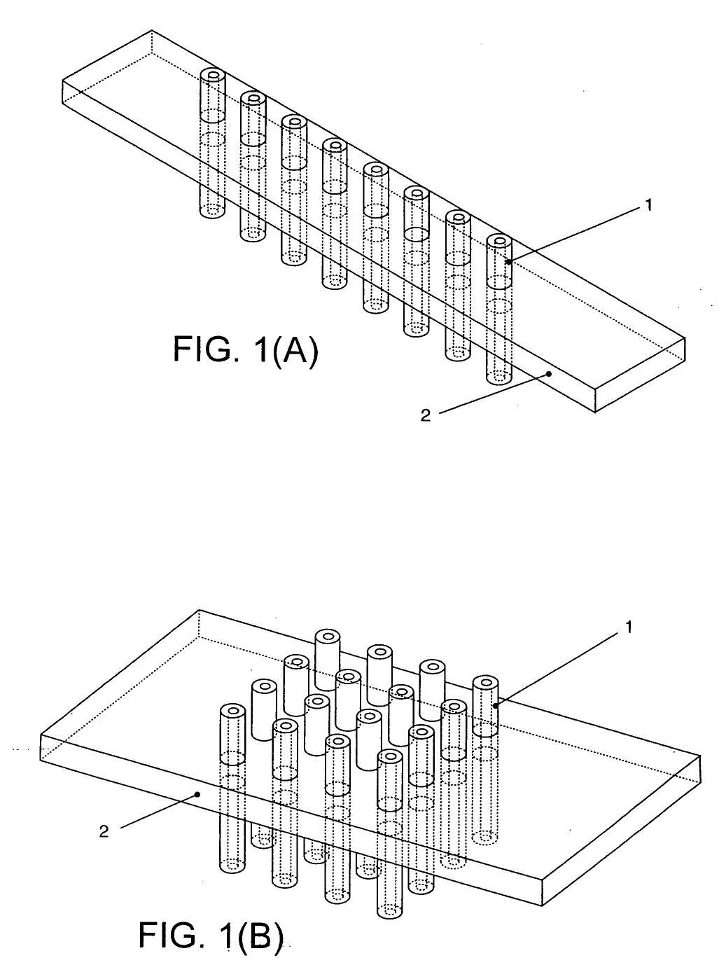

In FIG. 1, capillaries (1) are retained in their desired orientation by the housing portion (2). FIG. 1A shows a 1D array; FIG. 1B shows a 2D array.

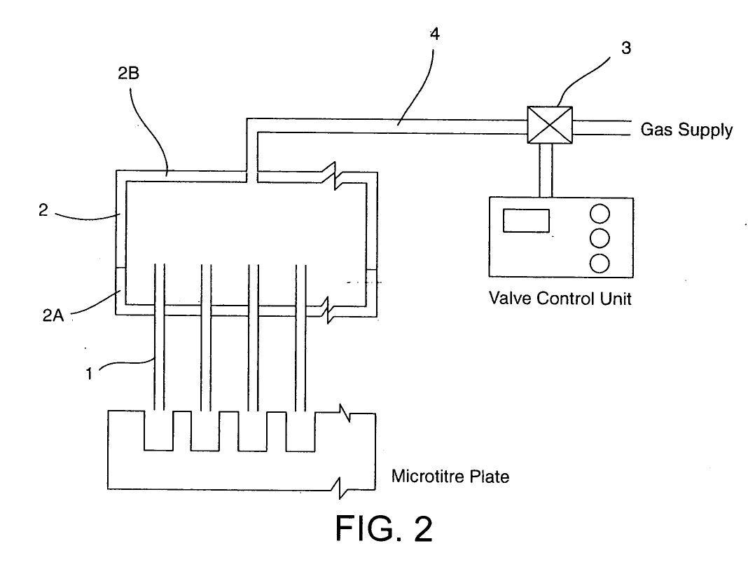

In FIG. 2, capillaries (1) are retained within a housing (2) which has two portions which form a cavity: portion 2A which retains the capillaries in their desired orientation and portion 2B which is provided with means to supply pressurised gas to the cavity. Portions 2A and 2B will desirably be separable, but will be capable of engaging to form a pressure tight seal. Pressurised gas is provided by means of a control valve (3), and suitable pipework (4).

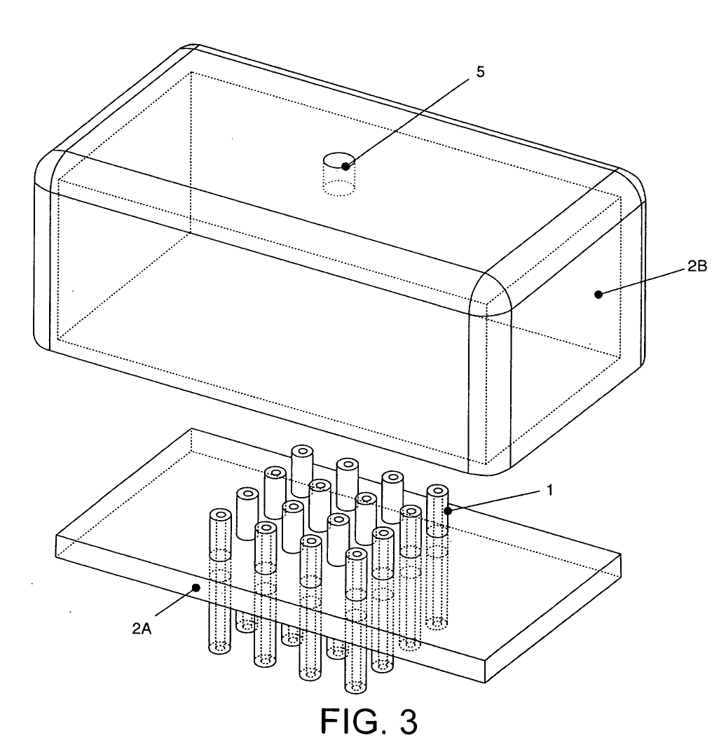

In FIG. 3, housing portions 2A and 2B are shown in an exploded view. Pressurised gas is supplied through orifice 5.

Throughout the specification and the claims which follow, unless the context requires otherwise, the word ‘comprise’, and variations such as ‘comprises’ and ‘comprising’, will be understood to imply the inclusion of a stated integer or step or group of integers but not to the exclusion of any other integer or step or group of integers or steps.

1. An apparatus for liquid sample handling which comprises:
(a) a plurality of hollow capillaries, each being open at both ends and of defined internal volume, wherein on contact of an open end of a capillary with a sample, said defined volume of sample is drawn up into the capillary by capillary action;
(b) a housing which retains the capillaries in their desired orientation; and
(c) means to effect sample removal from the capillaries.

2. An apparatus according to claim 1 wherein the capillaries are arranged in a regular orientation within the housing.

3. An apparatus according to claim 2 wherein the capillaries are arranged in a row.

4. An apparatus according to claim 2 wherein the capillaries are arranged in a 2-dimentional array.

5. An apparatus according to claim 1 wherein the means to effect sample removal is means to apply differential pressure between the ends of the capillaries.

6. An apparatus according to claim 5 wherein the means to apply differential pressure between the ends of the capillaries is means to apply pressure to one end of the capillaries.

7. An apparatus according to claim 1 wherein the means to effect sample removal is means to simultaneously remove sample from a plurality of capillaries.

8. An apparatus according to claim 7 wherein the means to apply pressure to one end of the capillaries comprises means to supply pressurised gas into an enclosed cavity formed around one end of a plurality of capillaries.

9. An apparatus according to claim 8 wherein the enclosed cavity is formed by the housing.

10. An apparatus according to claim 9 wherein the cavity formed by the housing is formed from two pressure sealed separable portions: one portion retaining the capillaries and one portion provided with means to supply pressurised gas to the cavity.

11. An apparatus according to claim 8 wherein the enclosed cavity formed around one end of the capillaries also acts as a reservoir for a liquid.

12. An apparatus according to claim 1 wherein the capillaries are made of glass or quartz.

13. An apparatus according to claim 12 wherein the capillaries are made of synthetically fused silica.

14. An apparatus according to claim 13 wherein the capillaries are coated or surface treated.

15. An apparatus according to claim 14 wherein the capillaries are coated or surface treated on their outer surface.

16. An apparatus according to claim 14 wherein the coating or surface treatment involves coating or treating with a non-wetting agent.

17. An apparatus according to claim 16 wherein the non-wetting agent is a coating of polyimide.

18. An apparatus according to claim 1 wherein the capillaries are modified such that one of their ends is sharp and pointed or otherwise adapted to enable the capillaries to perform a piercing function when they make contact with a surface, prior to sample removal.

19. An apparatus according to claim 1 wherein the internal volume of each capillary is between 50 nl and 1 μl.

20. An apparatus according to claim 19 wherein the internal volume of each capillary is between 50 nl and 250 nl.

21. An apparatus according to claim 1 wherein the capillaries within the housing are not all of the same length.

22. An apparatus according to claim 1 wherein one or more capillaries may be moved along a vertical axis within the housing.

23. An apparatus according to claim 1 wherein one or more capillaries may be reformatted within the plurality by altering the position of the capillaries within the housing, once filled with sample.

24. An apparatus for liquid sample handling which comprises
(a) a plurality of hollow translucent capillaries, each being open at both ends and of defined internal volume, wherein on contact of an open end of a capillary with a sample, said defined volume of sample is drawn up into the capillary by capillary action;
(e) a housing which retains the capillaries in their desired orientation;
(f) means to provide each capillary with photonic isolation from a neighbouring capillary;
(g) optical instrumentation and circuitry adapted to read a photonic response or event in each capillary; and
(e) means to effect sample removal from the capillaries.

25. A process for liquid sample transfer using an apparatus according to claim 1 which comprises:
(a) contacting the lower open end of the capillaries with the liquid to be transferred;
(b) uptake of liquid into the capillaries by capillary action; and
(c) effective removal of the liquid sample in each capillary into the receptacle to which it is to be transferred.

26. A process according to claim 25 wherein the effective removal of the sample is achieved by application of a pressure to the end of the capillaries.

27. A process for multiple liquid sample transfer using an apparatus according to claim 1 which comprises:
(a) contacting the lower open end of the capillaries with the first liquid to be transferred;
(b) uptake of liquid into the capillaries by capillary action;
(c) effective removal of the liquid sample in each capillary into the receptacle to which it is to be transferred;
(d) contacting lower open end of capillaries with rinsing liquid;
(e) uptake of rinsing liquid into the capillaries by capillary action;
(f) effective removal of the rinsing liquid in each capillary into a suitable waste receptacle;
(g) if desired, repetition of steps (d) to (f) one or more times;
(h) contacting the lower open end of the capillaries with a further liquid to be transferred;
(i) uptake of the further liquid sample into the capillaries by capillary action; and
(j) effective removal of the further liquid sample in each capillary into the receptacle to which it is to be transferred.

28. A process according to claim 27 which further comprises the step (k) of repeating steps (d) to (j) one or more times.

29. An apparatus for liquid sample handling which comprises:
(a) a plurality of hollow capillaries, each being open at both ends and of defined internal volume, wherein on contact of an open end of a capillary with a sample, said defined volume of sample is drawn up into the capillary by capillary action; and
(b) a housing which retains the capillaries in their desired orientation.
